(19) United States
(12) Patent Application Publication
(10) Pub. No.: US 2024/0428123 A1
(43) Pub. Date: Dec. 26, 2024

(54) UPDATING MACHINE LEARNING MODELS USING WEIGHTS BASED ON FEATURES CONTRIBUTING TO PREDICTIONS

(71) Applicant: Capital One Services, LLC, McLean, VA (US)

(72) Inventors: Samuel SHARPE, Cambridge, MA (US); Brian BARR, Schenectady, NY (US)

(73) Assignee: Capital One Services, LLC, McLean, VA (US)

(21) Appl. No.: 18/338,291

(22) Filed: Jun. 20, 2023

(51) Int. Cl. G06N 20/00; G06N 5/022

(52) U.S. Cl. CPC G06N 20/00; G06N 5/022

(57) ABSTRACT

Methods and systems are described herein for updating machine learning models using weights. The system inputs, into a machine learning model, a dataset including entries and features to obtain a relative impact of each feature. The system generates, using the relative impacts, a sparsity metric for each entry, each sparsity metric indicating a measure of a number of features used to generate a corresponding prediction. The system retrieves a sparsity threshold for assigning weights to the plurality of entries. The system generates an updated dataset based on assigning, to each entry within the dataset, a corresponding weight. Each corresponding weight is determined based on a relation of the sparsity metric to the sparsity threshold. The system inputs, into the machine learning model, the updated dataset to update the machine learning model based on the corresponding weights, where the machine learning model relies more heavily on entries with higher corresponding weights.

### BACKGROUND

Machine learning models typically rely on a large number of features to generate predictions, even though only a subset of those features may contribute significantly to predictions. For example, specific populations within the model inputs may rely on certain features while other populations within the model inputs may rely on certain other features. Overly complex machine learning models waste resources and are less efficient as compared to simpler machine learning models, for example, that are tailored for specific populations. Furthermore, predictions generated by simpler models are easier to understand and communicate. Initial attempts to handle overly complex models included limiting parameter space by reducing coefficients or a number of branches used by these models. However, these initial attempts do not base model updates on specific features contributing to any individual data points. These attempts are therefore limited to general simplification of the models and lack the ability to simplify models to rely on specific features contributing to data points. Thus, a mechanism is desired for generating and updating machine learning models using weights based on features contributing to predictions.

### SUMMARY

Methods and systems are described herein for generating and/or updating machine learning models using weights based on the impact of features on predictions. A model updating system may be built and configured to perform operations discussed herein. The model updating system may input a dataset into a machine learning model trained to obtain feature impact parameters (e.g., local explanations, attributions, or other parameters) indicating a relative impact of each feature. The dataset may include entries, with each entry including a number of features. For example, the dataset may include data related to program applicants, and each applicant may be associated with a number of features, such as application materials, scores, applicant attributes, references, or other features. The feature impact parameters may indicate the impact of an applicant's scores on a prediction of whether they will be admitted to the program, as well as the impact of the applicant's application materials on the prediction, and so on. The model updating system may then determine which features significantly impacted the prediction. For example, the model updating system may generate a sparsity metric for each prediction, each sparsity metric indicating a measure of a number of features used to generate a corresponding prediction. For example, a sparsity metric of one may indicate that only one feature (e.g., applicant's scores) contributed to the prediction of whether a particular applicant will be admitted to the program, a sparsity metric of two may indicate that two features (e.g., applicant's scores and references) contributed to the prediction of whether a particular applicant will be admitted to the program, and so on.

The model updating system may compare the sparsity metric for each entry with a sparsity threshold for assigning weights to the entries. The sparsity threshold may represent a target sparseness level. For example, the model updating system may have a desired sparseness of three (e.g., it is desired that each prediction from the simplified model rely on three features). In this example, the model updating system may set the sparsity threshold to three or may retrieve a sparsity threshold of three. In some embodiments, the model updating system may then generate an updated dataset by assigning weights to a weight to each entry within the dataset. The weights may be determined based on comparing the sparsity metric for each entry with the sparsity threshold. For example, for a particular entry (e.g., a particular applicant), if the sparseness is below the sparsity threshold (e.g., a prediction for the applicant only relied on two features, such as applicant's scores and references), the model updating system may weight that entry more heavily. For a particular entry (e.g., a particular applicant) having a sparsity metric below the sparsity threshold (e.g., a prediction for the applicant relied on four features), the model updating system may weight that entry less heavily.

The model updating system may then input the updated dataset into the machine learning model, causing the machine learning model to update based on the assigned weights. For example, the machine learning model may update its configurations (e.g., connection weights, biases, or other parameters) based on the updated dataset. Updates to connection weights may, for example, be reflective of the corresponding weights within the updated dataset. In this way, for example, the machine learning model may be updated to rely more heavily on entries having higher weights and to rely less heavily on entries having lower weights. The model updating system may assess the updated machine learning model for accuracy. If the model updating system determines that the machine learning model is not accurate enough, the model updating system may adjust the weights in the dataset and update the model again using the newly updated dataset. The model updating system may assess the newly updated machine learning model for accuracy and may adjust the weights again as necessary. Once the model updating system determines that the updated machine learning model is accurate enough, the model updating system may generate an indication of the updated machine learning model's accuracy.

In particular, the model updating system may use a machine learning model to generate predictions based on entries and features. The model updating system may input, into a machine learning model, a dataset including a plurality of entries, with each entry including a corresponding plurality of features, to obtain a plurality of feature impact parameters. The feature impact parameters may indicate a relative impact of each feature on a prediction for a corresponding entry of the plurality of entries. In some embodiments, the machine learning model may be trained to generate predictions for entries based on corresponding features. For example, the machine learning model may be trained to predict program admissions for applicants based on various features, such as application materials, scores, attributes, references, and other features. The model updating system may input a dataset including the applicants and each applicant's corresponding features. The model updating system may receive, from the machine learning model, predictions of program admissions for the applicants along with feature impact parameters indicating a relative impact of each feature on a prediction for a corresponding entry.

The model updating system may generate, based on the feature impact parameters, a corresponding sparsity metric for each entry. Each sparsity metric may indicate a measure of a number of features used to generate a corresponding prediction. For example, a sparsity metric of one may indicate that only one feature (e.g., applicant's scores) contributed to the prediction of whether they will be admitted to the program, a sparsity metric of two may indicate that two features (e.g., applicant's scores and references) contributed to the prediction of whether they will be admitted to the program, and so on. The model updating system may retrieve a sparsity threshold for assigning weights to the entries. The sparsity threshold may represent a target sparseness level. For example, the model updating system may have a desired sparseness of three (e.g., it is desired that each prediction from the simplified model rely on three features). In this example, the model updating system may set the sparsity threshold to three or may retrieve a sparsity threshold of three.

In some embodiments, the model updating system may assign weights to each entry within the dataset. In some embodiments, each weight is determined based on a relation of the corresponding sparsity metric to the sparsity threshold. For example, the weights may be determined based on comparing the sparsity metric for each entry with the sparsity threshold. For a particular entry (e.g., a particular applicant), if the sparseness is below the sparsity threshold (e.g., a prediction for the applicant only relied on two features, such as applicant's scores and references), the model updating system may weight that entry more heavily. For example, the model updating system may weight that entry 50% more heavily (e.g., 1.5 times) than an entry for which a sparsity metric equals the sparsity threshold (e.g., a sparsity metric of three). For another entry having a sparsity metric that is farther below the sparsity threshold (e.g., a prediction relying on only one feature), the model updating system may weight that entry even more heavily (e.g., 2 times than heavily than an entry for which a sparsity metric equals the sparsity threshold). For a particular entry (e.g., a particular applicant) having a sparsity metric below the sparsity threshold (e.g., a prediction for the applicant relied on four features), the model updating system may weight that entry less heavily. The model updating system may weight that entry 50% less heavily (e.g., 0.5 times) than an entry for which a sparsity metric equals the sparsity threshold (e.g., a sparsity metric of three). For another entry having a sparsity metric that is farther above the sparsity threshold (e.g., a prediction relying on six features), the model updating system may weight that entry even less heavily (e.g., 0.1 times as heavily as an entry for which a sparsity metric equals the sparsity threshold). The model updating system may generate an updated dataset by adding or adjusting a corresponding weight for each entry within the dataset.

The model updating system may input the updated dataset into the machine learning model to cause the machine learning model to update itself based on the corresponding weights. For example, the updating may cause the machine learning model to update its configurations (e.g., weights, biases, or other parameters). In some embodiments, the updated machine learning model may rely more heavily on entries with higher corresponding weights (e.g., entries for which predictions rely on fewer features). The model updating system may then determine an accuracy of the updated machine learning model. In response to determining that the accuracy of the machine learning model does not meet an accuracy threshold, the model updating system may generate a new updated dataset by assigning an adjusted corresponding weight to each entry within the dataset. In some embodiments, the model updating system may adjust the weights to be less drastic. In the above example, for an entry with a sparsity metric of two and a sparsity threshold of three, the model updating system may initially weight that entry 50% more heavily (e.g., 1.5 times) than an entry for which a sparsity metric equals the sparsity threshold. In response to determining that the accuracy of the machine learning model does not meet the accuracy threshold, the model updating system may adjust the weight so that the entry is weighted only 25% more heavily (e.g., 1.25 times). The model updating system may similarly adjust the weights of entries that have sparsity metrics above the sparsity threshold (e.g., from 0.5 times to 0.75 times).

The model updating system may then input, into the machine learning model, the new updated dataset to update the machine learning model based on the adjusted corresponding weights. For example, the updating may cause the machine learning model to update its configurations (e.g., weights, biases, or other parameters) again. The model updating system may then determine an accuracy of the updated machine learning model. If the new accuracy of the machine learning model still does not meet the accuracy threshold, the model updating system may repeat the process of adjusting the weights. If the new accuracy of the machine learning model does meet the accuracy threshold, the model updating system may generate an indication of the new accuracy. For example, the model updating system may generate the indication of the new accuracy for display to a user.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for updating machine learning models using weights based on features contributing to predictions, in accordance with one or more embodiments.

FIG. 2 illustrates an exemplary machine learning model, in accordance with one or more embodiments.

FIG. 3 illustrates a data structure for input into a machine learning model, in accordance with one or more embodiments.

FIG. 4 illustrates a data structure representing impacts of features on predictions, in accordance with one or more embodiments.

FIG. 5 illustrates a data structure including weighted entries, in accordance with one or more embodiments.

FIG. 6 illustrates a computing device, in accordance with one or more embodiments.

FIG. 7 shows a flowchart of the process for updating machine learning models using weights based on features contributing to predictions, in accordance with one or more embodiments.

### DETAILED DESCRIPTION

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

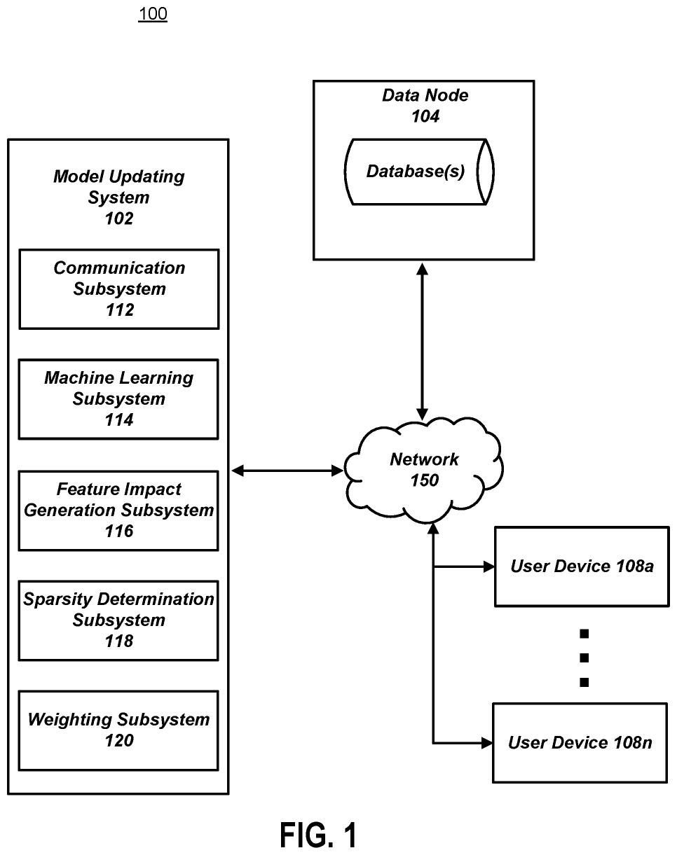

FIG. 1 shows an illustrative system 100 for updating machine learning models using weights based on features contributing to predictions, in accordance with one or more embodiments. System 100 may include model updating system 102, data node 104, and user devices 108a-108n. Model updating system 102 may include communication subsystem 112, machine learning subsystem 114, feature impact generation subsystem 116, sparsity determination subsystem 118, weighting subsystem 120, and/or other subsystems. In some embodiments, only one user device may be used, while in other embodiments, multiple user devices may be used. The user devices 108a-108n may be associated with one or more users. The user devices 108a-108n may be associated with one or more user accounts. In some embodiments, user devices 108a-108n may be computing devices that may receive and send data via network 150. User devices 108a-108n may be end-user computing devices (e.g., desktop computers, laptops, electronic tablets, smartphones, and/or other computing devices used by end users). User devices 108a-108n may output (e.g., via a graphical user interface) run applications, output communications, receive inputs, or perform other actions.

Model updating system 102 may execute instructions for updating machine learning models using weights based on features contributing to predictions. Model updating system 102 may include software, hardware, or a combination of the two. For example, communication subsystem 112 may include a network card (e.g., a wireless network card and/or a wired network card) that is associated with software to drive the card. In some embodiments, model updating system 102 may be a physical server or a virtual server that is running on a physical computer system. In some embodiments, model updating system 102 may be configured on a user device (e.g., a laptop computer, a smart phone, a desktop computer, an electronic tablet, or another suitable user device).

Data node 104 may store various data, including one or more machine learning models, training data, communications, and/or other suitable data. In some embodiments, data node 104 may also be used to train machine learning models. Data node 104 may include software, hardware, or a combination of the two. For example, data node 104 may be a physical server, or a virtual server that is running on a physical computer system. In some embodiments, model updating system 102 and data node 104 may reside on the same hardware and/or the same virtual server/computing device. Network 150 may be a local area network, a wide area network (e.g., the Internet), or a combination of the two.

Model updating system 102 (e.g., machine learning subsystem 114) may include or manage one or more machine learning models. For example, one or more machine learning models may be trained to generate predictions for entries based on corresponding features. In some embodiments, one or more machine learning models may further output feature impact parameters associated with predictions. Machine learning subsystem 114 may include software components, hardware components, or a combination of both. For example, machine learning subsystem 114 may include software components (e.g., API calls) that access one or more machine learning models. Machine learning subsystem 114 may access training data, for example, in memory. In some embodiments, machine learning subsystem 114 may access the training data on data node 104 or on user devices 108a-108n. In some embodiments, the training data may include entries with corresponding features and corresponding output labels for the entries. In some embodiments, machine learning subsystem 114 may access one or more machine learning models. For example, machine learning subsystem 114 may access the machine learning models on data node 104 or on user devices 108a-108n.

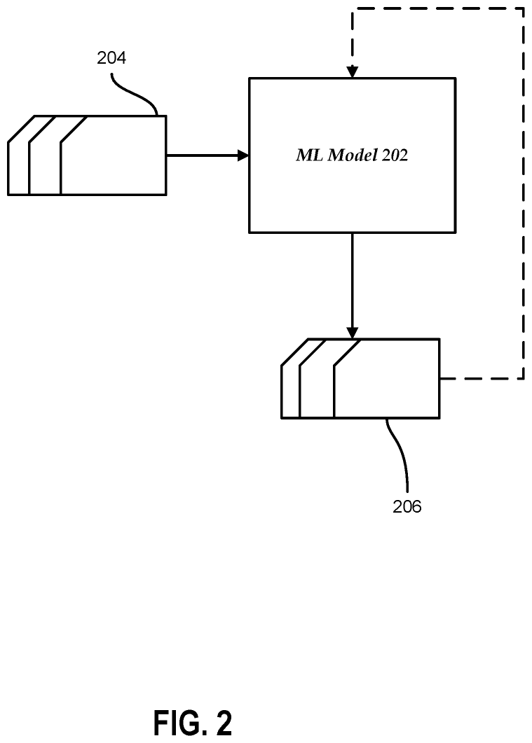

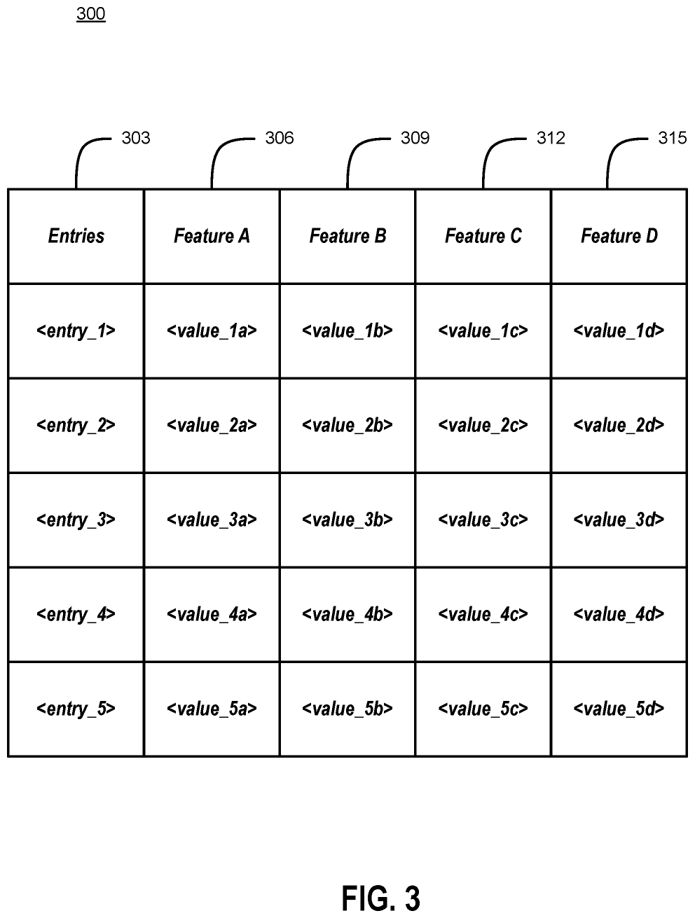

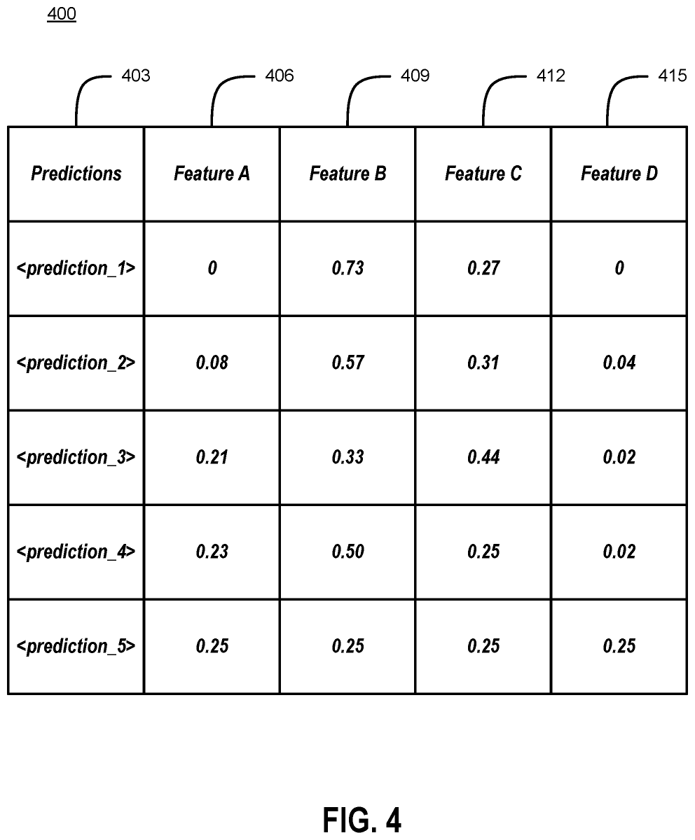

FIG. 2 illustrates an exemplary machine learning model 202, in accordance with one or more embodiments. The machine learning model may have been trained using features associated with entries, such as application materials, scores, applicant attributes, references, or other features associated with applicants for admission to a particular program. The machine learning model may have been trained to predict whether the applicants would be admitted to the program based on the features associated with the applicants. In some embodiments, machine learning model 202 may be included in machine learning subsystem 114 or may be associated with machine learning subsystem 114. Machine learning model 202 may take input 204 (e.g., entries and corresponding features, as described in greater detail with respect to FIG. 3) and may generate outputs 206 (e.g., predictions, as described in greater detail with respect to FIG. 4). In some embodiments, the outputs may further include feature impact parameters, as described in greater detail with respect to FIG. 4. The output parameters may be fed back to the machine learning model as inputs to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function, which combines the values of all of its inputs together. Each connection (or the neural unit itself) may have a threshold function that a signal must surpass before it propagates to other neural units. The machine learning model may be self-learning and/or trained, rather than explicitly programmed, and may perform significantly better in certain areas of problem solving, as compared to computer programs that do not use machine learning. During training, an output layer of the machine learning model may correspond to a classification of machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or a supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

Machine learning subsystem 114 may input, into a machine learning model (e.g., machine learning model 202, as shown in FIG. 2), a dataset that includes a plurality of entries, with each entry comprising a corresponding plurality of features to obtain a plurality of predictions. In some embodiments, the machine learning model is trained to generate predictions for entries based on corresponding features, as discussed above in relation to FIG. 2.

FIG. 3 illustrates a data structure 300 for inputting data into a machine learning model. Data structure 300 may include entries 303, as well as a plurality of features, including feature 306, feature 309, feature 312, and feature 315. In some embodiments, data structure 300 may be a subset of a larger data structure. Entries 303 may include data related to a plurality of applicants for admission to a particular program. Feature 306 may be application materials associated with the applicants, feature 309 may be scores, feature 312 may be applicant attributes, and feature 315 may be references. Based on data structure 300, the machine learning model (e.g., machine learning model 202) may generate a plurality of predictions for entries 303 (e.g., applicants) based on features 306, 309, 312, and 315 (e.g., materials, scores, attributes, and references).

Model updating system 102 (e.g., feature impact generation subsystem 116) may generate, for each entry of the plurality of entries, a plurality of feature impact parameters. In some embodiments, a feature impact parameter is a metric for indicating a relative impact of each feature of the corresponding plurality of features on each prediction of the plurality of predictions. Feature impact generation subsystem 116 may use a number of techniques to generate the feature impact parameters. As an example, feature impact generation subsystem 116 may use a local linear model, where coefficients determine the estimated impact of each feature. If a feature coefficient is non-zero, then feature impact generation subsystem 116 may determine the feature impact parameter of the feature according to the sign and magnitude of the coefficient. As another example, feature impact generation subsystem 116 may perturb the input around a feature's neighborhood and assess how the machine learning model's predictions behave. Feature impact generation subsystem 116 may then weight these perturbed data points by their proximity to the original example and learn an interpretable model on those and the associated predictions. As another example, feature impact generation subsystem 116 may randomly generate entries surrounding a particular entry. Feature impact generation subsystem 116 may then use the machine learning model to generate predictions of the generated random entries. Feature impact generation subsystem 116 may then construct a local regression model using the generated random entries and their generated predictions from the machine learning model. Finally, the coefficients of the regression model may indicate the contribution of each feature to the prediction of the particular entry according to the machine learning model. In some embodiments, feature impact generation subsystem 116 may use these or other techniques to generate the feature impact parameters for the entries based on the features.

FIG. 4 illustrates a data structure 400 representing impacts of features on predictions. Data structure 400 may include predictions 403 and feature impact parameters for features associated with predictions 403. In some embodiments, data structure 400 may be a subset of a larger data structure. In some embodiments, predictions 403 may represent predictions for entries 303, as shown in FIG. 3. Feature 406, feature 409, feature 412, and feature 415 may correspond to feature 306, feature 309, feature 312, and feature 315, as shown in FIG. 3. In some embodiments, data structure 400 may include feature impact parameters indicating the impacts of feature 406, feature 409, feature 412, and feature 415 on predictions 403. In some embodiments, predictions 403 may be binary (e.g., yes or no, approved or not approved, admitted or not admitted, etc.), a percentage (e.g., 57% likely to be approved, 10% likely to be admitted, etc.), a portion (e.g., 0.33, ⅓, etc.), or in some other form. FIG. 4 shows the feature impact parameters of feature 406, feature 409, feature 412, and feature 415 in the form of relative impact on predictions 403, normalized to one.

For example, for the first entry, data structure 400 shows that feature 406 and feature 415 did not impact <prediction_1>, while <prediction_1> was based 73% on feature 409 and 27% on feature 412. The first entry may represent a first applicant, who is not predicted to be admitted to a particular program. Data structure 400 may indicate that the prediction that the first applicant is not predicted to be admitted to the program is based mostly (e.g., 73%) on the first applicant's scores and partially (e.g., 27%) on the first applicant's attributes and is not based on the first applicant's application materials or references. In another example, the second entry may represent a second applicant, who is predicted to be admitted to the program. Data structure 400 may indicate that the prediction that the second applicant is predicted to be admitted to the program is based partially (e.g., 8%) on the second applicant's application materials, partially (e.g., 57%) on the second applicant's scores, partially (e.g., 31%) on the second applicant's attributes, and partially (e.g., 4%) on the second applicant's references.

In some embodiments, feature impact generation subsystem 116 may determine a feature impact threshold for assessing which features of the corresponding plurality of features have contributed to each prediction. For example, the threshold may indicate a percentage, portion, or other cutoff below which a feature is not considered to have impacted a prediction significantly. For example, if a feature (e.g., references) has a feature impact parameter that falls below the threshold, the feature may not be considered to significantly impact the prediction. In some embodiments, the feature impact threshold may be set to zero, such that any feature having a feature impact parameter above zero for a particular prediction is considered to impact the prediction. In some embodiments, the feature impact threshold may be predetermined or entered manually at a particular level. For example, a higher feature impact threshold (e.g., 0.2) limits the number of features that are considered to impact predictions, whereas a lower feature impact threshold (0.05) expands the number of features that are considered to impact predictions. In some embodiments, feature impact generation subsystem 116 may determine, for each entry, which features have relative impacts on the corresponding prediction that meet a feature impact threshold. Based on certain features having respective relative impacts that do not meet the feature impact threshold for any entries of the plurality of entries, machine learning subsystem 114 may train a new machine learning model by excluding those certain features.

In some embodiments, determining the feature impact threshold may include inputting a modified dataset including “noise” into the machine learning model (e.g., machine learning model 202, as shown in FIG. 2). “Noise” may refer to unwanted behaviors within input data. Feature impact generation subsystem 116 may modify the dataset (e.g., data structure 300, as shown in FIG. 3) to include an additional feature for each entry of the plurality of entries (e.g., entries 303), where the values for the additional features are randomly generated. For example, the entries for the additional feature may be the “noise.” Feature impact generation subsystem 116 may generate, for each entry of the additional plurality of entries, a corresponding additional feature impact parameter indicating a relative impact of a corresponding additional feature on each prediction of the plurality of predictions. Feature impact generation subsystem 116 may determine the feature impact threshold based on the additional feature impact parameters. For example, feature impact generation subsystem 116 may set the feature impact threshold equal to an average of the additional feature impact parameters, as a highest additional feature impact parameter or at another level based on the additional feature impact parameters.

Model updating system 102 (e.g., sparsity determination subsystem 118) may generate, using the plurality of feature impact parameters and the feature impact threshold, a sparsity metric for each prediction. The sparsity metric may indicate how many features contributed significantly to the prediction. For example, the sparsity metric may indicate that a particular applicant's scores and application materials contributed significantly to a prediction of whether that applicant would be admitted to the program. In some embodiments, the sparsity metric may indicate which features of the corresponding plurality of features have relative impacts that meet the feature impact threshold for the prediction. In some embodiments, generating the sparsity metric for each prediction may involve determining whether a feature impact parameter for each feature associated with the prediction meets the feature impact threshold. For example, the sparsity metric of each feature for each entry may be a “yes” or “no” or may be a value of zero or one to indicate whether the respective feature impact parameter meets the feature impact threshold. Based on a first subset of feature impact parameters for a first subset of features meeting the feature impact threshold, sparsity determination subsystem 118 may determine that the first subset of features contributes to the prediction. For example, sparsity determination subsystem 118 may assign the first subset of features a value of one to indicate that the first subset of features contributes to the prediction. Based on a second subset of feature impact parameters for a second subset of features not meeting the feature impact threshold, sparsity determination subsystem 118 may determine that the second subset of features does not contribute to the prediction. For example, sparsity determination subsystem 118 may assign the second subset of features a value of zero to indicate that the first subset of features does not contribute to the prediction. Sparsity determination subsystem 118 may generate the sparsity metric for the prediction to include the first subset of features and exclude the second subset of features.

In some embodiments, feature impact generation subsystem 116 may adjust the feature impact threshold and sparsity determination subsystem 118 may generate a new set of sparsity metrics. For example, for a first feature impact threshold (e.g., 1%), sparsity determination subsystem 118 may generate a first set of sparsity metrics for the features for each entry. For a second feature impact threshold (e.g., 2%), sparsity determination subsystem 118 may generate a second set of sparsity metrics for the features for each entry, and so on. Sparsity determination subsystem 118 may continue to generate sparsity metrics for a number of different feature impact thresholds. Sparsity determination subsystem 118 may graph the sparsity metrics for each different feature impact threshold to generate a curve. In some embodiments, machine learning subsystem 114 may compare machine learning models based on a comparison of the areas under the curves. Machine learning subsystem 114 may select a machine learning model based on, for example, minimizing or maximizing the area under the curve.

In some embodiments, sparsity determination subsystem 118 may retrieve a sparsity threshold for assigning weights to entries within a dataset (e.g., data structure 400, as shown in FIG. 4). For example, sparsity determination subsystem 118 may retrieve a sparsity threshold that represents a desired number of features for each prediction to rely upon. In some embodiments, sparsity determination subsystem 118 may determine or generate the sparsity threshold based on a desired number of features for each prediction to rely upon. For example, sparsity determination subsystem 118 may determine the sparsity threshold based on a desired number of features to be included within a first subset of features for the plurality of entries, where the first subset of features includes features meeting a feature impact threshold. As an example, sparsity determination subsystem 118 may determine that each prediction of program admission should rely on three or fewer features. Thus, sparsity determination subsystem 118 may determine that the sparsity threshold is three. Sparsity determination subsystem 118 may then compare the sparsity metric for each entry to the sparsity threshold.

Model updating system 102 (e.g., weighting subsystem 120) may generate an updated dataset based on assigning, to each entry of the plurality of entries within the dataset, a corresponding weight. In some embodiments, weighting subsystem 120 may determine each weight based on a relation or comparison between the corresponding sparsity metric and the sparsity threshold. In some embodiments, a first entry may have a sparsity metric (e.g., two features) lower than the sparsity threshold (i.e., not meeting the sparsity threshold). The sparsity metric for the first entry being lower than the sparsity threshold may indicate that the first entry relies on a desired number of features (e.g., fewer than three features) to generate predictions. Weighting subsystem 120 may thus assign the first entry a higher weight (e.g., 1.5). In some embodiments, if the sparsity metric for another entry were even lower than the sparsity metric, weighting subsystem 120 may assign that entry an even higher weight (e.g., 2). A second entry may have a sparsity metric (e.g., four features) higher than the sparsity threshold (i.e., meeting the sparsity threshold). The sparsity metric for the second entry being higher than the sparsity threshold may indicate that the second entry relies on too many features (e.g., more than three features) to generate predictions. Weighting subsystem 120 may thus assign the second entry a lower weight (e.g., 0.75). In some embodiments, if the sparsity metric for another entry were even higher than the sparsity metric, weighting subsystem 120 may assign that entry an even lower weight (e.g., 0.5). In some embodiments, a third entry may have a sparsity metric equal to the sparsity threshold (i.e., meeting). The sparsity metric for the third entry being equal to the sparsity threshold may indicate that the third entry relies on the desired number of features (e.g., three features) to generate predictions. Weighting subsystem 120 may leave the third entry unweighted, assign the third entry a weight of 1, assign the third entry a higher weight, or assign the third entry a lower weight.

In some embodiments, the weighting subsystem 120 may determine a distance between the sparsity metric and the sparsity threshold and may generate a weight for the first entry based on the distance. For example, for an entry having a sparsity metric below the sparsity threshold, weighting subsystem 120 may assign a higher weight that is proportional or otherwise related to the distance of the sparsity metric below the sparsity threshold. As an example, for a sparsity threshold of 3, weighting subsystem 120 may assign a weight of 1.5 to an entry with a sparsity metric of 2, a weight of 2 to an entry with a sparsity metric of 1, and so on. For an entry having a sparsity metric above the sparsity threshold, weighting subsystem 120 may assign a lower weight that is proportional or otherwise related to the distance of the sparsity metric above the sparsity threshold. As an example, for a sparsity threshold of 3, weighting subsystem 120 may assign a weight of 0.75 to an entry with a sparsity metric of 4, a weight of 0.5 to an entry with a sparsity metric of 5, and so on.

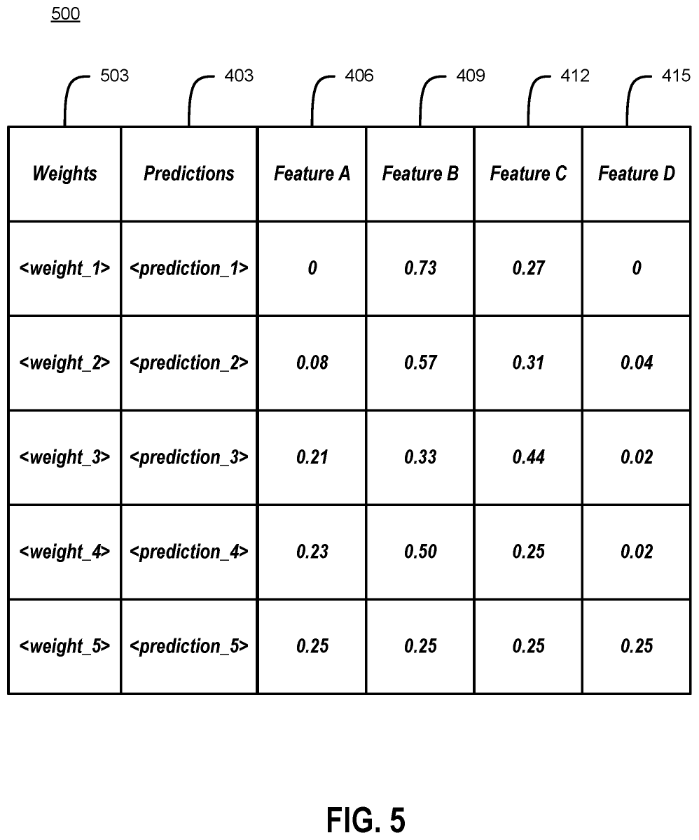

FIG. 5 illustrates a data structure 500 including weighted entries, in accordance with one or more embodiments. Data structure 500 may include weights 503, predictions 403, and feature impact parameters for features associated with predictions 403. In some embodiments, data structure 500 may be a subset of a larger data structure. In some embodiments, data structure 500 may include data structure 400. For example, weighting subsystem 120 may append weights 503 to data structure 400 to generate an updated data structure (i.e., data structure 500). In some embodiments, data structure 500 may include feature impact parameters indicating the impacts of feature 406, feature 409, feature 412, and feature 415 on predictions 403. FIG. 5 shows the feature impact parameters of feature 406, feature 409, feature 412, and feature 415 in the form of relative impact on predictions 403, normalized to one.

In some embodiments, sparsity determination subsystem 118 may determine a sparsity metric for each entry (e.g., predictions 403) within data structure 500. For example, the sparsity metric may indicate which features contributed significantly to the prediction. In some embodiments, the sparsity metric indicates which features of the corresponding plurality of features have relative impacts that meet the feature impact threshold for the prediction. In some embodiments, a feature impact threshold for data structure 500 may be 0.2. For example, the sparsity metric may indicate that, for the first applicant within data structure 500, the applicant's scores (e.g., feature 409) and the applicant's attributes (e.g., feature 412) contributed significantly to a prediction (e.g., predictions 403) of whether the first applicant would be admitted to the program based on feature 409 and feature 412 having relative impacts on the prediction greater than 0.2 for the first applicant. The first applicant may thus have a sparsity metric of two. For the second applicant within data structure 500, the applicant's scores (e.g., feature 409) and the applicant's attributes (e.g., feature 412) contributed significantly to a prediction (e.g., predictions 403) of whether the second applicant would be admitted to the program based on feature 409 and feature 412 having relative impacts on the prediction greater than 0.2 for the second applicant. The second applicant may thus have a sparsity metric of two. For the third applicant within data structure 500, the applicant's materials (e.g., feature 406), the applicant's scores (e.g., feature 409), and the applicant's attributes (e.g., feature 412) contributed significantly to a prediction (e.g., predictions 403) of whether the third applicant would be admitted to the program based on feature 406, feature 409, and feature 412 having relative impacts on the prediction greater than 0.2 for the third applicant. The third applicant may thus have a sparsity metric of three. Accordingly, the fourth applicant may have a sparsity metric of three, and the fifth applicant may have a sparsity metric of four.

Weighting subsystem 120 may generate data structure 500 by assigning, to each prediction of predictions 403, a corresponding weight. In some embodiments, weighting subsystem 120 may determine each weight based on a relation or comparison between the corresponding sparsity metric and a sparsity threshold. The sparsity threshold may represent a desired number of features for each prediction to rely upon. As an example, sparsity determination subsystem 118 may determine that each prediction of program admission should rely on three or fewer features. The first and second applicants within data structure 500 may each have a sparsity metric of two, as discussed above, which does not meet the sparsity threshold of three. As such, the predictions for the first and second applicants may be weighted more heavily (e.g., 1.5). The third and fourth applicants within data structure 500 may each have a sparsity metric of three, as discussed above, which is equal to the sparsity threshold of three. As such, the predictions for the third and fourth applicants may be unweighted, assigned a weight of 1, or assigned a different weight. The fifth applicant within data structure 500 may have a sparsity metric of four, as discussed above, which exceeds the sparsity threshold of three. As such, the prediction for the fifth applicant may be weighted less heavily (e.g., 0.75).

Returning to FIG. 1, once weighting subsystem 120 has assigned weights to the entries (e.g., to generate data structure 500, as shown in FIG. 5), machine learning subsystem 114 may input the updated dataset into a machine learning model (e.g., machine learning model 202, as shown in FIG. 2). Inputting the updated dataset into the machine learning model may cause the machine learning model to update based on the corresponding weights. For example, the updating may cause the machine learning model to rely more heavily on entries with higher corresponding weights.

In some embodiments, machine learning subsystem 114 may determine an accuracy for the machine learning model. The accuracy may represent a fraction of predictions of the machine learning model that are accurate. In some embodiments, machine learning subsystem 114 may compare the accuracy of the updated machine learning model and the accuracy of the machine learning model prior to updating. As an example, after updating, the machine learning model may rely on fewer features for each prediction due to the heavier weighting of predictions with lower sparsity metrics. As such, the updated machine learning model may be less accurate than it had been prior to updating. Machine learning subsystem 114 may thus compare the accuracy of the updated machine learning model with how accurate the machine learning model had been before updating. To do so, machine learning subsystem 114 may measure the accuracy before causing the machine learning model to update based on the weights. As an example, prior to updating, if machine learning subsystem 114 inputs data for one hundred applicants into the machine learning model and the machine learning model accurately predicts program admission for ninety seven of the applicants, the accuracy may indicate that the machine learning model has an accuracy of 0.97 or 97% before updating. In some embodiments, the accuracy may be represented in another form. After updating, if machine learning subsystem 114 inputs data for one hundred applicants into the machine learning model and the updated machine learning model accurately predicts program admission for eighty five of the applicants, the accuracy may indicate that the updated machine learning model has an accuracy of 0.85 or 85%.

In some embodiments, machine learning subsystem 114 may determine whether the updated machine learning model is accurate enough. For example, machine learning subsystem 114 may compare the accuracy of the updated machine learning model to an accuracy threshold. An accuracy threshold may be a minimum acceptable accuracy of the machine learning model. As an example, the accuracy threshold may be 0.8 or 80%. In response to determining that an accuracy of the updated machine learning model (e.g., 0.85) meets the accuracy threshold (e.g., 0.8), communication subsystem 112 may generate an indication of the new accuracy. For example, the model updating system may output the indication of the new accuracy via a user interface or display.

As an example, the accuracy threshold may be 0.9 or 90%. In response to determining that an accuracy of the updated machine learning model (e.g., 0.85) does not meet the accuracy threshold (e.g., 0.9), weighting subsystem 120 may adjust the weights of the predictions. For example, if the updated machine learning model is not accurate enough, that may indicate that the predictions have been weighted too heavily. In response, weighting subsystem 120 may generate a new updated dataset based on assigning an adjusted corresponding weight to each entry within the dataset. For example, weighting subsystem 120 may decrease the higher weights and increase the lower weights. As discussed in relation to FIG. 5, the initial weights 503 may be 1.5 for the first and second entries within data structure 500, 1 for the second and third entries within data structure 500, and 0.75 for the fifth entry within data structure 500. Weighting subsystem 120 may adjust these weights to decrease the higher weights and increase the lower weights, for example, to make the weights less drastic. For example, weighting subsystem 120 may adjust the weights 503 to 1.2 for the first and second entries and to 0.9 for the fifth entry. In some embodiments, the higher weights may remain higher than the lower weights. In some embodiments, the higher weights may remain higher than a weight associated with the entries having sparsity metrics equal to the sparsity threshold (e.g., higher than 1). The lower weights may remain lower than the weight associated with the entries having sparsity metrics equal to the sparsity threshold (e.g., lower than 1).

In some embodiments, machine learning subsystem 114 may input the new updated dataset into the machine learning model (e.g., machine learning model 202, as shown in FIG. 2). Inputting the new updated dataset into the machine learning model may cause the machine learning model to update based on the adjusted corresponding weights. For example, the updating may cause the machine learning model to rely slightly less heavily on the entries with higher corresponding weights and slightly more heavily on the entries with lower corresponding weights.

Machine learning subsystem 114 may determine a new accuracy for the machine learning model. For example, the new accuracy may be 0.89. In comparison to an accuracy threshold of 0.9, the new accuracy may not meet the accuracy threshold. If the new accuracy does not meet the accuracy threshold, weighting subsystem 120 may repeat the process of adjusting the weights to make the weighting less drastic, and machine learning subsystem 114 may again measure the accuracy of the newly updated machine learning model. Model updating system 102 may repeat this process until the newly updated machine learning model is accurate enough. For example, the newly updated machine learning model may reach an accuracy level of 0.9. In response to determining that an accuracy of the newly updated machine learning model (e.g., 0.9) meets the accuracy threshold (e.g., 0.9), communication subsystem 112 may generate an indication of the new accuracy. For example, the model updating system may output the indication of the new accuracy via a user interface or display.

In some embodiments, sparsity determination subsystem 118 may retrieve, generate, or determine a lower sparsity threshold. For example, sparsity determination subsystem 118 may determine a lower desired number of features for each prediction to rely upon. Sparsity determination subsystem 118 may set a lower sparsity threshold to test how the lower sparsity threshold affects the accuracy of the resulting updated machine learning model. For example, sparsity determination subsystem 118 may test whether the lower sparsity threshold is too detrimental to the accuracy. Model updating system 102 may repeat the steps outlined above. For example, weighting subsystem 120 may generate a new updated dataset based on assigning, to each entry of the plurality of entries within the dataset, a new corresponding weight, where each new corresponding weight is determined based on a new relation of the sparsity metric to the lower sparsity threshold. Machine learning subsystem 114 may input, into the machine learning model, the new updated dataset to update the machine learning model based on the new corresponding weights. Machine learning subsystem 114 may determine a new accuracy associated with the updated machine learning model and may compare the new accuracy with an accuracy of the machine learning model using the original sparsity threshold. Machine learning subsystem 114 may determine a difference between the accuracy metric with the original sparsity threshold and the new accuracy metric with the lower sparsity threshold. In response to determining that the difference does not meet a difference threshold, model updating system 102 may keep the lower sparsity threshold (e.g., fewer desired features per prediction) and may generate the new accuracy metric (e.g., for display). In response to determining that the difference does meet a difference threshold, model updating system 102 may keep the original sparsity threshold.

In some embodiments, sparsity determination subsystem 118 may retrieve, generate, or determine a higher sparsity threshold. For example, sparsity determination subsystem 118 may determine a higher desired number of features for each prediction to rely upon. Sparsity determination subsystem 118 may set a higher sparsity threshold to test how the higher sparsity threshold affects the accuracy of the resulting updated machine learning model. For example, sparsity determination subsystem 118 may test whether the higher sparsity threshold is beneficial enough to the accuracy. Model updating system 102 may repeat the steps outlined above. For example, weighting subsystem 120 may generate a new updated dataset based on assigning, to each entry of the plurality of entries within the dataset, a new corresponding weight, where each new corresponding weight is determined based on a new relation of the sparsity metric to the higher sparsity threshold. Machine learning subsystem 114 may input, into the machine learning model, the new updated dataset to update the machine learning model based on the new corresponding weights. Machine learning subsystem 114 may determine a new accuracy associated with the updated machine learning model and may compare the new accuracy with an accuracy of the machine learning model using the original sparsity threshold. Machine learning subsystem 114 may determine a difference between the accuracy metric with the original sparsity threshold and the new accuracy metric with the lower sparsity threshold. In response to determining that the difference meets a difference threshold, model updating system 102 may keep the higher sparsity threshold (e.g., more desired features per prediction) and may generate the new accuracy metric (e.g., for display). In response to determining that the difference does not meet a difference threshold, model updating system 102 may keep the original sparsity threshold.

### Computing Environment

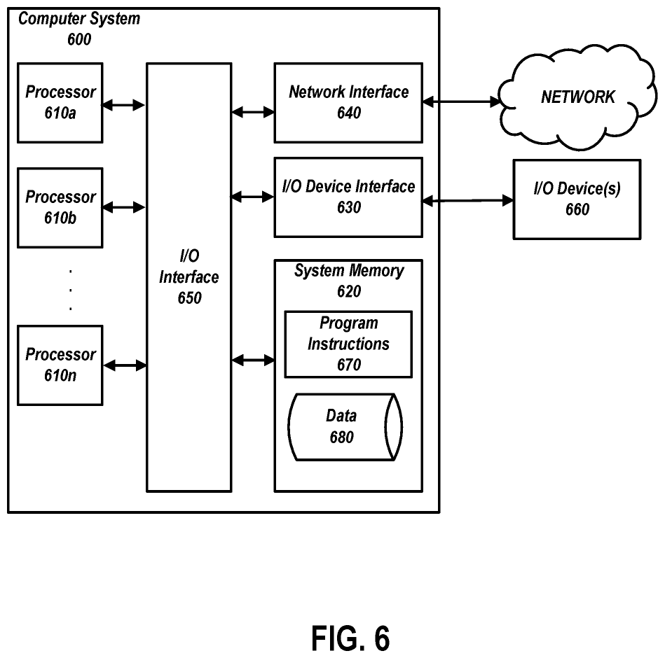

FIG. 6 shows an example computing system 600 that may be used in accordance with some embodiments of this disclosure. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, for example., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computing system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computing system 600 through a wired or wireless connection. I/O devices 660 may be connected to computing system 600 from a remote location. I/O devices 660 located on remote computer systems, for example, may be connected to computing system 600 via a network and network interface 640.

Network interface 640 may include a network adapter that provides for connection of computing system 600 to a network. Network interface 640 may facilitate data exchange between computing system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory computer-readable storage medium. A non-transitory computer-readable storage medium may include a machine-readable storage device, a machine-readable storage substrate, a memory device, or any combination thereof. A non-transitory computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computing system 600, or multiple computer systems 600 configured to host different portions or instances of embodiments. Multiple computer systems 600 may provide for parallel or sequential processing/execution of one or more portions of the techniques described herein.

Those skilled in the art will appreciate that computing system 600 is merely illustrative, and is not intended to limit the scope of the techniques described herein. Computing system 600 may include any combination of devices or software that may perform or otherwise provide for the performance of the techniques described herein. For example, computing system 600 may include or be a combination of a cloud-computing system, a data center, a server rack, a server, a virtual server, a desktop computer, a laptop computer, a tablet computer, a server device, a user device, a mobile telephone, a personal digital assistant (PDA), a mobile audio or video player, a game console, a vehicle-mounted computer, a Global Positioning System (GPS), or the like. Computing system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

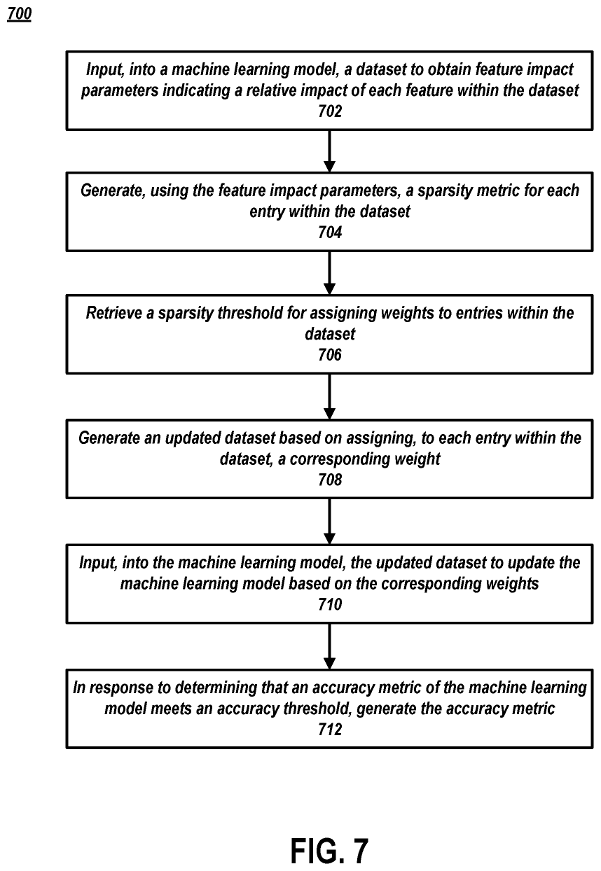

FIG. 7 shows a flowchart of the process 700 for updating machine learning models using weights based on features contributing to predictions, in accordance with one or more embodiments. For example, the system may use process 700 (e.g., as implemented on one or more system components described above) to assign weights based on a number of features contributing to a given prediction and to update the model accordingly.

At 702, model updating system 102 (e.g., using one or more of processors 610a-610n) may input, into a machine learning model, a dataset comprising entries for features to obtain feature impact parameters. The dataset may include a plurality of entries with each entry including a corresponding plurality of features. The machine learning model may be trained to generate predictions for entries based on corresponding features. In some embodiments, process 700 may obtain the dataset from system memory 620, via the network, or elsewhere. Model updating system 102 may train the machine learning model using one or more of processors 610a-610n or may retrieve the trained machine learning model from system memory 620, via the network, or elsewhere.

At 704, model updating system 102 (e.g., using one or more of processors 610a-610n) may generate, using the feature impact parameters, a sparsity metric for each entry within the dataset. The sparsity metric for each entry may indicate a measure of a number of features used to generate a prediction corresponding to each entry. In some embodiments, model updating system 102 may generate the sparsity metric using one or more of processors 610a-610n.

At 706, model updating system 102 (e.g., using one or more of processors 610a-610n) may retrieve a sparsity threshold for assigning weights to the entries within the dataset. The sparsity threshold may represent a target sparseness level. For example, a sparsity threshold of three may represent a desired sparseness of three (e.g., it is desired that each prediction from the model rely on three or fewer features). In some embodiments, model updating system 102 may retrieve the sparsity threshold from system memory 620, via the network, or elsewhere.

At 708, model updating system 102 (e.g., using one or more of processors 610a-610n) may generate an updated dataset based on assigning, to each entry within the dataset, a corresponding weight. In some embodiments, each weight is determined based on a relation of the corresponding sparsity metric to the sparsity threshold. For example, the weights may be determined based on comparing the sparsity metric for each entry with the sparsity threshold. In some embodiments, model updating system 102 may generate the updated dataset using one or more of processors 610a-610n.

At 710, model updating system 102 (e.g., using one or more of processors 610a-610n) may input, into the machine learning model, the updated dataset to update the machine learning model based on the corresponding weights. For example, the updating may cause the machine learning model to update its configurations (e.g., weights, biases, or other parameters). In some embodiments, the updated machine learning model may rely more heavily on entries with higher corresponding weights (e.g., entries for which predictions rely on fewer features). In some embodiments, model updating system 102 may input the updated dataset into the machine learning model using one or more of processors 610a-610n.

At 712, model updating system 102 (e.g., using one or more of processors 610a-610n) may generate an accuracy metric for the machine learning model in response to determining that the accuracy metric meets an accuracy threshold. For example, the model updating system may generate the indication of the accuracy for display to a user. In some embodiments, model updating system 102 may generate the accuracy using I/O device interface 630.

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 7.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method, the method comprising inputting, into a machine learning model, a dataset comprising a plurality of entries with each entry comprising a plurality of features to obtain a plurality of feature impact parameters indicating a relative impact of each feature of the plurality of features, generating, using the plurality of feature impact parameters, a sparsity metric for each entry, wherein each sparsity metric indicates a measure of a number of features used to generate a corresponding prediction, retrieving a sparsity threshold for assigning weights to the plurality of entries, generating an updated dataset based on assigning, to each entry of the plurality of entries within the dataset, a corresponding weight, wherein each corresponding weight is determined based on a relation of the sparsity metric to the sparsity threshold, inputting, into the machine learning model, the updated dataset to update the machine learning model based on the corresponding weights, wherein the machine learning model is updated in accordance with the corresponding weights, and in response to determining that an accuracy metric of the machine learning model meets an accuracy threshold, generating the accuracy metric.
2. The method of any one of the preceding embodiments, wherein assigning, to each entry of the plurality of entries within the dataset, the corresponding weight further comprises determining, for each sparsity metric, a distance between the sparsity metric and the sparsity threshold, and generating a weight for a corresponding entry based on the distance.
3. The method of any one of the preceding embodiments, wherein assigning, to each entry of the plurality of entries within the dataset, the corresponding weights comprises accessing each entry of the plurality of entries within the dataset, extracting the sparsity metric of each entry, and assigning the corresponding weights to the plurality of entries by assigning one or more higher weights to one or more first entries having one or more first sparsity metrics that do not meet the sparsity threshold and by assigning one or more lower weights to one or more second entries having one or more second sparsity metrics that meet the sparsity threshold.
4. The method of any one of the preceding embodiments, further comprising, in response to determining that the accuracy metric of the machine learning model does not meet the accuracy threshold, generating a new updated dataset based on assigning, to each entry of the plurality of entries within the dataset, an adjusted corresponding weight, inputting, into the machine learning model, the dataset to update the machine learning model based on the adjusted corresponding weights, and in response to determining that a new accuracy metric of the machine learning model meets the accuracy threshold, generating the new accuracy metric.
5. The method of any one of the preceding embodiments, wherein assigning the adjusted corresponding weight for each entry of the plurality of entries within the dataset comprises decreasing the one or more higher weights and increasing the one or more lower weights, wherein the one or more higher weights remain higher than the one or more lower weights.
6. The method of any one of the preceding embodiments, wherein generating, using the plurality of feature impact parameters, the sparsity metric for each entry further comprises determining a feature impact threshold for assessing which features of the plurality of features have contributed to each prediction generated by the machine learning model for each entry, and generating, using the plurality of feature impact parameters and the feature impact threshold, the sparsity metric for each entry, wherein the sparsity metric indicates which features of the plurality of features have relative impacts that meet the feature impact threshold for the entry.
7. The method of any one of the preceding embodiments, wherein generating, using the plurality of feature impact parameters and the feature impact threshold, the sparsity metric for each entry further comprises determining whether a feature impact parameter for each feature associated with the entry meets the feature impact threshold, based on a first subset of the plurality of feature impact parameters for a first subset of features associated with the entry meeting the feature impact threshold, determining that the first subset of features contributes to a prediction generated by the machine learning model for the entry, based on a second subset of the plurality of feature impact parameters for a second subset of features associated with the entry not meeting the feature impact threshold, determining that the second subset of features does not contribute to the prediction, and generating the sparsity metric for the entry to include the first subset of features and exclude the second subset of features.
8. The method of any one of the preceding embodiments, further comprising determining the sparsity threshold based on a desired number of features to be included within the first subset of features for the plurality of entries.
9. The method of any one of the preceding embodiments, further comprising determining a lower sparsity threshold for weighting each entry based on a lower desired number of features to be included within the first subset of features for the plurality of entries.
10. The method of any one of the preceding embodiments, further comprising generating a new updated dataset based on assigning, to each entry of the plurality of entries within the dataset, a new corresponding weight, wherein each new corresponding weight is determined based on a new relation of the sparsity metric to the lower sparsity threshold, inputting, into the machine learning model, the new updated dataset to update the machine learning model based on the new corresponding weights, wherein the updated machine learning model is associated with a new accuracy metric, determining a difference between the accuracy metric and the new accuracy metric, and in response to determining that the difference does not meet a difference threshold, generating the new accuracy metric.
11. The method of any one of the preceding embodiments, further comprising determining a higher sparsity threshold for weighting each entry based on a higher desired number of features to be included within the first subset of features for the plurality of entries, generating a new updated dataset based on assigning, to each entry of the plurality of entries within the dataset, a new corresponding weight, wherein each new corresponding weight is determined based on a new relation of the sparsity metric to the higher sparsity threshold, inputting, into the machine learning model, the new updated dataset to update the machine learning model based on the new corresponding weights, wherein the updated machine learning model is associated with a new accuracy metric, determining a difference between the accuracy metric and the new accuracy metric, and in response to determining that the difference meets a difference threshold, generating the new accuracy metric.
12. The method of any one of the preceding embodiments, further comprising determining, for each entry, which features of the plurality of features have relative impacts on the corresponding prediction that meet a feature impact threshold, and based on one or more features having respective relative impacts that do not meet the feature impact threshold for any entries of the plurality of entries, training a new machine learning model by excluding the one or more features from the plurality of features.
13. The method of any one of the preceding embodiments, further comprising determining the accuracy metric based on a comparison between the updated machine learning model and the machine learning model.
14. A tangible, non-transitory, machine-readable medium storing instructions that, when executed by a data processing apparatus, cause the data processing apparatus to perform operations comprising those of any of embodiments 1-13.
15. A system comprising one or more processors and memory storing instructions that, when executed by the processors, cause the processors to effectuate operations comprising those of any of embodiments 1-13.
16. A system comprising means for performing any of embodiments 1-13.
17. A system comprising cloud-based circuitry for performing any of embodiments 1-13.

What is claimed is:

1. A system for updating machine learning models, the system comprising:
at least one processor, at least one memory, and computer-readable media having computer-executable instructions stored thereon, the computer-executable instructions, when executed by the at least one processor, causing the system to perform operations comprising:
inputting, into a machine learning model, a dataset comprising a plurality of entries with each entry comprising a corresponding plurality of features to obtain a plurality of feature impact parameters indicating a relative impact of each feature on a prediction for a corresponding entry of the plurality of entries, wherein the machine learning model is trained to generate predictions for entries based on corresponding features;
generating, based on the plurality of feature impact parameters, a corresponding sparsity metric for each entry, wherein each sparsity metric indicates a measure of a number of features used to generate a corresponding prediction;
retrieving a sparsity threshold for assigning weights to the plurality of entries;
generating an updated dataset based on assigning, to each entry of the plurality of entries within the dataset, a corresponding weight, wherein each weight is determined based on a relation of the corresponding sparsity metric to the sparsity threshold;
inputting, into the machine learning model, the updated dataset to retrain the machine learning model based on the corresponding weights, wherein a training routine adjusts connection weights of the machine learning model according to the corresponding weights;
in response to determining that an accuracy of the machine learning model does not meet an accuracy threshold:
generating a new updated dataset based on assigning, to each entry of the plurality of entries within the dataset, an adjusted corresponding weight; and
inputting, into the machine learning model, the new updated dataset to update the machine learning model based on the adjusted corresponding weights; and
in response to determining that a new accuracy of the machine learning model meets the accuracy threshold, generating an indication of the new accuracy.

2. A method comprising:
inputting, into a machine learning model, a dataset comprising a plurality of entries with each entry comprising a plurality of features to obtain a plurality of feature impact parameters indicating a relative impact of each feature of the plurality of features;
generating, using the plurality of feature impact parameters, a sparsity metric for each entry, wherein each sparsity metric indicates a measure of a number of features used to generate a corresponding prediction;
retrieving a sparsity threshold for assigning weights to the plurality of entries;
generating an updated dataset based on assigning, to each entry of the plurality of entries within the dataset, a corresponding weight, wherein each corresponding weight is determined based on a relation of the sparsity metric to the sparsity threshold;
inputting, into the machine learning model, the updated dataset to update the machine learning model based on the corresponding weights, wherein the machine learning model is updated in accordance with the corresponding weights; and
in response to determining that an accuracy metric of the machine learning model meets an accuracy threshold, generating an indication of the accuracy metric.

3. The method of claim 2, wherein assigning, to each entry of the plurality of entries within the dataset, the corresponding weight further comprises:
determining, for each sparsity metric, a distance between the sparsity metric and the sparsity threshold; and
generating a weight for a corresponding entry based on the distance.

4. The method of claim 2, wherein assigning, to each entry of the plurality of entries within the dataset, the corresponding weights comprises:
accessing each entry of the plurality of entries within the dataset;
extracting the sparsity metric of each entry; and
assigning the corresponding weights to the plurality of entries by assigning one or more higher weights to one or more first entries having one or more first sparsity metrics that do not meet the sparsity threshold and by assigning one or more lower weights to one or more second entries having one or more second sparsity metrics that meet the sparsity threshold.

5. The method of claim 4, further comprising, in response to determining that the accuracy metric of the machine learning model does not meet the accuracy threshold:
generating a new updated dataset based on assigning, to each entry of the plurality of entries within the dataset, an adjusted corresponding weight;
inputting, into the machine learning model, the dataset to update the machine learning model based on the adjusted corresponding weights; and
in response to determining that a new accuracy metric of the machine learning model meets the accuracy threshold, generating a new indication of the new accuracy metric.

6. The method of claim 5, wherein assigning the adjusted corresponding weight for each entry of the plurality of entries within the dataset comprises decreasing the one or more higher weights and increasing the one or more lower weights, wherein the one or more higher weights remain higher than the one or more lower weights.

7. The method of claim 2, wherein generating, using the plurality of feature impact parameters, the sparsity metric for each entry further comprises:
determining a feature impact threshold for assessing which features of the plurality of features have contributed to each prediction generated by the machine learning model for each entry; and
generating, using the plurality of feature impact parameters and the feature impact threshold, the sparsity metric for each entry, wherein the sparsity metric indicates which features of the plurality of features have relative impacts that meet the feature impact threshold for the entry.

8. The method of claim 7, wherein generating, using the plurality of feature impact parameters and the feature impact threshold, the sparsity metric for each entry further comprises:
determining whether a feature impact parameter for each feature associated with the entry meets the feature impact threshold;
based on a first subset of the plurality of feature impact parameters for a first subset of features associated with the entry meeting the feature impact threshold, determining that the first subset of features contributes to a prediction generated by the machine learning model for the entry;
based on a second subset of the plurality of feature impact parameters for a second subset of features associated with the entry not meeting the feature impact threshold, determining that the second subset of features does not contribute to the prediction; and
generating the sparsity metric for the entry to include the first subset of features and exclude the second subset of features.

9. The method of claim 8, further comprising determining the sparsity threshold based on a desired number of features to be included within the first subset of features for the plurality of entries.

10. The method of claim 8, further comprising determining a lower sparsity threshold for weighting each entry based on a lower desired number of features to be included within the first subset of features for the plurality of entries.

11. The method of claim 10, further comprising:
generating a new updated dataset based on assigning, to each entry of the plurality of entries within the dataset, a new corresponding weight, wherein each new corresponding weight is determined based on a new relation of the sparsity metric to the lower sparsity threshold;
inputting, into the machine learning model, the new updated dataset to update the machine learning model based on the new corresponding weights, wherein the updated machine learning model is associated with a new accuracy metric;
determining a difference between the accuracy metric and the new accuracy metric; and
in response to determining that the difference does not meet a difference threshold, generating the new accuracy metric.

12. The method of claim 8, further comprising:
determining a higher sparsity threshold for weighting each entry based on a higher desired number of features to be included within the first subset of features for the plurality of entries;
generating a new updated dataset based on assigning, to each entry of the plurality of entries within the dataset, a new corresponding weight, wherein each new corresponding weight is determined based on a new relation of the sparsity metric to the higher sparsity threshold;
inputting, into the machine learning model, the new updated dataset to update the machine learning model based on the new corresponding weights, wherein the updated machine learning model is associated with a new accuracy metric;
determining a difference between the accuracy metric and the new accuracy metric; and
in response to determining that the difference meets a difference threshold, generating the new accuracy metric.

13. The method of claim 2, further comprising:
determining, for each entry, which features of the plurality of features have relative impacts on the corresponding prediction that meet a feature impact threshold; and
based on one or more features having respective relative impacts that do not meet the feature impact threshold for any entries of the plurality of entries, training a new machine learning model by excluding the one or more features from the plurality of features.

14. The method of claim 2, further comprising determining the accuracy metric based on a comparison between the updated machine learning model and the machine learning model.

15. One or more non-transitory, computer-readable media storing instructions that, when executed by one or more processors, cause operations comprising:
inputting, into a machine learning model, a dataset comprising a plurality of entries with each entry comprising a plurality of features to obtain a plurality of feature impact parameters indicating a relative impact of each feature of the plurality of features;
generating, using the plurality of feature impact parameters, a sparsity metric for each entry, wherein each sparsity metric indicates a measure of a number of features used to generate a corresponding prediction;
retrieving a sparsity threshold for assigning weights to the plurality of entries;
generating an updated dataset based on assigning, to each entry of the plurality of entries within the dataset, a corresponding weight, wherein each corresponding weight is determined based on a relation of the sparsity metric to the sparsity threshold;
inputting, into the machine learning model, the updated dataset to update the machine learning model based on the corresponding weights, wherein the machine learning model is updated in accordance with the corresponding weights; and
in response to determining that an accuracy metric of the machine learning model meets an accuracy threshold, generating an indication of the accuracy metric.

16. The one or more non-transitory, computer-readable media of claim 15, wherein, to generate, using the plurality of feature impact parameters, the sparsity metric for each entry, the instructions further cause the one or more processors to perform operations comprising:
determining a feature impact threshold for assessing which features of the plurality of features have contributed to each prediction generated by the machine learning model for each entry; and
generating, using the plurality of feature impact parameters and the feature impact threshold, the sparsity metric for each entry, wherein the sparsity metric indicates which features of the plurality of features have relative impacts that meet the feature impact threshold for the entry.

17. The one or more non-transitory, computer-readable media of claim 16, wherein, to generate, using the plurality of feature impact parameters and the feature impact threshold, the sparsity metric for each entry, the instructions further cause the one or more processors to perform operations comprising:
determining whether a feature impact parameter for each feature associated with the entry meets the feature impact threshold;
based on a first subset of the plurality of feature impact parameters for a first subset of features associated with the entry meeting the feature impact threshold, determining that the first subset of features contributes to a prediction generated by the machine learning model for the entry;
based on a second subset of the plurality of feature impact parameters for a second subset of features associated with the entry not meeting the feature impact threshold, determining that the second subset of features does not contribute to the prediction; and
generating the sparsity metric for the entry to include the first subset of features and exclude the second subset of features.

18. The one or more non-transitory, computer-readable media of claim 17, wherein the instructions further cause the one or more processors to perform operations comprising determining the sparsity threshold based on a desired number of features to be included within the first subset of features for the plurality of entries.

19. The one or more non-transitory, computer-readable media of claim 17, wherein the instructions further cause the one or more processors to perform operations comprising:
determining a lower sparsity threshold for weighting each entry based on a lower desired number of features to be included within the first subset of features for the plurality of entries;
generating a new updated dataset based on assigning, to each entry of the plurality of entries within the dataset, a new corresponding weight, wherein each new corresponding weight is determined based on a new relation of the sparsity metric to the lower sparsity threshold;
inputting, into the machine learning model, the new updated dataset to update the machine learning model based on the new corresponding weights, wherein the updated machine learning model is associated with a new accuracy metric;
determining a difference between the accuracy metric and the new accuracy metric; and
in response to determining that the difference does not meet a difference threshold, generating the new accuracy metric.

20. The one or more non-transitory, computer-readable media of claim 17, wherein the instructions further cause the one or more processors to perform operations comprising:
determining a higher sparsity threshold for weighting each entry based on a higher desired number of features to be included within the first subset of features for the plurality of entries;
generating a new updated dataset based on assigning, to each entry of the plurality of entries within the dataset, a new corresponding weight, wherein each new corresponding weight is determined based on a new relation of the sparsity metric to the higher sparsity threshold;
inputting, into the machine learning model, the new updated dataset to update the machine learning model based on the new corresponding weights, wherein the updated machine learning model is associated with a new accuracy metric;
determining a difference between the accuracy metric and the new accuracy metric; and
in response to determining that the difference meets a difference threshold, generating the new accuracy metric.
